(19) United States
(12) Patent Application Publication
(10) Pub. No.: US 2012/0177929 A1
(43) Pub. Date: Jul. 12, 2012

(54) COMBINATION OF TWO TRIAZINE UV ABSORBERS FOR COATING ON POLYCARBONATE

(75) Inventors: Birgit Meyer Zu Berstenhorst, Leverkusen (DE); Frank Buckel, Kempen (DE); Gunther Stollwerck, Krefeld (DE)

(73) Assignee: Bayer MaterialScience AG, Leverkusen (DE)

(21) Appl. No.: 13/496,725

(22) PCT Filed: Sep. 13, 2010
(86) PCT No.: PCT/EP2010/063392

§ 371 Date: Mar. 16, 2012

(30) Foreign Application Priority Data
Sep. 19, 2009 (EP) 10 2009 042 307.9

(51) Int. Cl. B32B 27/08

(52) U.S. Cl. 428/412

(57) ABSTRACT

The present invention relates to a multilayer product comprising at least one first, second, and third layer, wherein the first layer contains polycarbonate, the second layer contains a UV protection layer on the basis of alkyl acrylate containing two triazine compounds as UV stabilizers, and the third layer is a scratchproof layer also containing UV absorbers. The invention further relates to the production and use of said multilayer products and of products, such as laminations, that contain said multilayer products.

The present invention relates to a multilayer product comprising at least a first, second and third layer, wherein the first layer contains polycarbonate, the second layer is a UV protective layer based on alkyl acrylate containing two triazine compounds as UV stabilisers, and the third layer is a scratch-resistant layer which likewise contains UV absorbers. The invention additionally relates to the production of such multilayer products and to moulded articles, such as, for example, glazing, which contain the mentioned multilayer products.

Moulded articles of polycarbonate have already been known for a relatively long time. However, polycarbonate has the disadvantage that it is not itself inherently UV-stable. The sensitivity curve of bisphenol A polycarbonate has the highest sensitivity between 320 nm and 330 nm. Below 330 nm, no solar radiation reaches the earth, and above 350 nm, this polycarbonate is so insensitive that yellowing no longer occurs.

In order to protect polycarbonate from the harmful effects of UV rays in the atmosphere, UV stabilisers, which absorb the UV radiation and convert it into harmless thermal energy, are generally used.

For permanent protection, it is advantageous to effectively filter out the harmful UV radiation even before it reaches the polycarbonate surface, as is possible by the use of UV protective layers, for example UV-absorber-containing coextruded layers, UV-absorber-containing films or UV-absorber-containing lacquers on polycarbonate.

Typical UV absorber classes which are known to be usable for that purpose are 2-hydroxy-benzophenones, 2-(2-hydroxyphenyl)benzotriazoles, 2-(2-hydroxyphenyl)-1,3-5-triazines, 2-cyanoacrylates and oxalanilides.

For outdoor applications, improved scratch protection is also necessary in most cases. This can be achieved by applying a scratch-resistant lacquer. Current prior art therefor are sol-gel silicate lacquers (see e.g. EP-A 0 339 257, U.S. Pat. No. 5,041,313) and other inorganic hybrid lacquers (EP-A 0 570 165). The property profile of organosilane-based lacquers additionally includes excellent stability to weathering and light, and resistance to heat, alkali, solvents and moisture.

Triazine-based UV absorbers exhibit the highest stability in PMMA and UV-curable acrylate laquers in comparison to other UV absorbers. The stability can be increased further by addition of HALS systems (Hindered Amine Light Stabilizer) (J. Pospisil et al., Prog. Polym. Sci. 25 (2000) 1261-1335).

EP-A 1308084 discloses generally the combination of a triazine-based UV absorber and a benzotriazole-based UV absorber, optionally also with HALS. A large number of possible applications are disclosed for a large number of UV absorber variants, including also use in a coating. The UV absorber combination claimed therein is not described concretely either for use in polycarbonate or for use in a coating composition. An arbitrary combination from the lists, or even the combinations of the UV absorbers described in EP-A 1308084 that are mentioned as being preferred or in the examples, give no indication which of the UV absorbers must be chosen in order to provide optimal protection against weathering for a multilayer structure of polycarbonate—UV protective layer—scratch-resistant coating.

EP-A 0502816 describes the use of phenyl- or p-tolyl-substituted triazines in combination with HALS in lacquer systems, for example as a protective topcoat for motor vehicles.

WO 00/66675 A discloses the use of biphenyl-substituted triazines, also in mixtures, in adhesives in combination with HALS.

WO 2008/107095 A discloses polycarbonate compositions containing mixtures of a biphenyl-substituted triazine derivative and a further UV absorber in specific proportions. The polycarbonate is thereby UV-protected and unlacquered.

WO 2006/108520 A describes the use of biphenyl-substituted triazines of formula I in UV protective layers of PMMA for polycarbonate. It is mentioned in the application that high initial extinction and low UV absorber degradation during weathering are necessary.

However, the above-mentioned applications do not contain any teaching regarding the choice of a particularly efficient combination of UV absorbers in multilayer systems comprising a polycarbonate layer, a UV protective layer and a scratch-resistant lacquer.

The UV-stabilised polycarbonate moulded articles known from the prior art still exhibit unsatisfactory long-term stability against yellowing and haze in many applications, in particular in outdoor applications, where high demands must be met in terms of scratch resistance and in terms of the permanently good visual impression (such as, for example, in glazing).

For most applications, a polycarbonate moulded article must exhibit as little yellowing and haze as possible under irradiation of 9 MJ/m² at 340 nm (which corresponds to 3 years' outdoor weathering in Florida).

Weathering is carried out in this test in an Atlas Ci 5000 Weatherometer with a radiation intensity of 0.75 W/m² at 340 nm and a dry/rain cycle of 102:18 minutes over a total period of 3000 hours (which corresponds to 8.1 MJ/m² at 340 nm). The black panel temperature is 70° C., the sample chamber temperature is 55° C. and the humidity is 40%.

The object underlying the present invention is to provide scratch-resistant polycarbonate moulded articles which exhibit as little yellowing and haze as possible under irradiation of 9 MJ/m² at 340 nm under the mentioned conditions.

Surprisingly, it has been found that, for these requirements, a multilayer structure containing specific combinations of UV absorbers is markedly superior to those according to the prior art in allegedly equivalent combinations. The invention accordingly provides a multilayer product comprising at least a first layer (A), a second layer (B) and a third layer (C), wherein the first layer (A) contains a polycarbonate, the second layer (B) is a UV protective layer of polyalkyl (meth)acrylate which contains a combination of UV stabilisers according to formulae (I) and (II), and the third layer (C) is a UV-protected scratch-resistant layer.

The multilayer product according to the invention can comprise further layers, in particular a further UV protective layer (D), which is likewise a layer of alkyl acrylate and contains in each case at least one UV stabiliser, for example selected from the above-mentioned UV absorber classes such as 2-hydroxy-benzophenones, 2-(2-hydroxyphenyl)benzotriazoles, 2-(2-hydroxyphenyl)-1,3,5-triazines, 2-cyanoacrylates and oxalanilides, preferred triazine derivatives are UV absorbers according to formulae (I) and (II), and a further scratch-resistant layer (E). The layer sequence in this case is (C)-(B)-(A)-(D)-(E), and the layers (B) and (D) and also (C) and (E) can have the same or different compositions. A further possible variant is to apply only one scratch-resistant layer containing UV absorber to the inside, because fewer demands are made in terms of the UV protection there. The layer sequence is then (C)-(B)-(A)-(E).

The article can additionally contain further coatings. In addition to the coatings (B), (C), (D), (E), there come into consideration as further coatings (F), for example, IR-absorbing layers, IR-reflecting layers, electrically conductive layers, electroluminescent layers, coloured and printed layers for decorative purposes, electrically conductive printed layers, as are used, for example, for automotive window heating, optionally also layers containing heating wires, antireflective layers, no-drop coatings, anti-fog coatings, anti-fingerprint coatings and/or combinations thereof. Such layers can be applied or can be present as intermediate layers and/or as an interior cover layer.

At least one of the UV absorbers used in layers (B) and optionally (D) of the multilayer products according to the invention has the general formula (I)

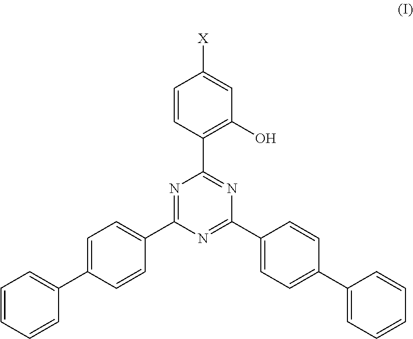

wherein X denotes OR¹; OCH₂CH₂OR¹; OCH₂CH(OH)CH₂OR¹ or OCH(R²)COOR³, where R¹ represents in each case branched or unbranched C₁-C₁₃-alkyl, C₂-C₂₀-alkenyl, C₆-C₁₂-aryl or CO—C₁-C₁₈-alkyl; R² is H or branched or unbranched C₁-C₈-alkyl; and R³ denotes C₁-C₁₂-alkyl; C₂-C₁₂-alkenyl or C₅-C₆-cycloalkyl.

X is preferably OCH(R²)COOR³; particularly preferably where R²═CH₃ and R³═C₈H₁₇.

At least one of the UV absorbers used in layers (B) and optionally (D) of the multilayer products according to the invention has the general formula (II)

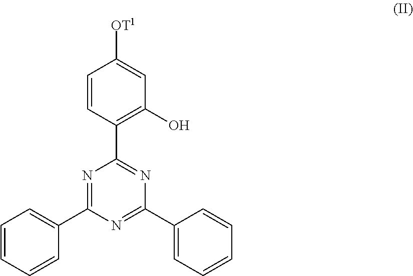

wherein T¹ is C₁-C₁₈-alkyl or C₄-C₁₈-alkyl, interrupted by COO or OCO or O, or interrupted by O and substituted by OH.

T¹ is preferably C₁-C₁₈-alkyl and particularly preferably C₈H₁₇.

Such biphenyl-substituted and phenyl-substituted triazines of the general formulae I and II are known in principle from WO 96/28431 A, DE-A 19739797; WO 00/66675 A; U.S. Pat. No. 6,225,384; U.S. Pat. No. 6,255,483; EP-A 1 308 084 and FR-A 2812299.

The UV protective layers (B) and (D) according to the invention can contain further UV absorbers, which are preferably selected from the group containing 2-hydroxy-benzophenones, 2-(2-hydroxy-phenyl)benzotriazoles, 2-(2-hydroxyphenyl)-1,3,5-triazines, 2-cyanoacrylates and oxalanilides.

The UV protective layers (B) and (D) can be cured lacquer formulations, film layers or coextruded layers.

UV protective layers (B) and (D) according to the invention of cured lacquer formulations contain as binder material a physically drying polyacrylate resin containing methyl methacrylate as the main component and optionally a further alkyl methacrylate having a longer, linear or branched alkyl chain (—CₙH₂ₙ₊₁ where n>1), preferably 1≦n≦5. 10, particularly preferably linear where n=3 (butyl methacrylate). The ratio of the two methacrylate units is 75 to 100% methyl methacrylate and 25 to 0% alkyl methacrylate, preferably 85 to 100% methyl methacrylate and 15% to 0% alkyl methacrylate, particularly preferably 90 to 100% methyl methacrylate and 10% to 0% alkyl methacrylate.

UV protective layers (B) and (D) according to the invention in the form of films and coextruded layers contain as polymer matrix a polyacrylate consisting of alkyl methacrylate, preferably having alkyl chain lengths of below 10 carbon atoms (—CₙH₂ₙ₊₁ where n<10), particularly preferably exclusively with n=1 (methyl methacrylate).

Because a particular minimum extinction of the UV protective layer is necessary for permanent UV protection, the required UV absorber concentration depends on the layer thickness.

The UV absorbers of formulae (I) and (II) in layer (B) are used in a ratio UV absorber of formula (I): UV absorber of formula (II) of from 9.9:0.1 to 6.1:3.9, preferably from 9:1 to 7:3, particularly preferably from 8.5:1.5 to 7.5:2.5.

For layer thicknesses from 1 to 100 μm, preferably from 1 to 30 μm, particularly preferably from 1 to 10 μm, the UV protective layers according to the invention in the form of cured lacquer formulations contain from 0.5 to 20 wt. %, preferably from 1 to 15 wt. %, particularly preferably from 1.5 to 10 wt. %, based on the solids content of the lacquer formulation, of mixtures of the UV absorbers of formulae (I) and (II) in the above-described mixing ratio, wherein formulations having layer thicknesses after application and curing of 1 μm contain at least 10 wt. %, preferably ≧15 wt. %, those of 5 μm contain at least 2 wt. %, preferably ≧3 wt. %, and those of 10 μm contain at least 1 wt. %, preferably ≧1.5 wt. %.

For layer thicknesses from 1 to 500 μm, preferably from 1 to 100 μm, particularly preferably from 2 to 50 μm, the UV protective layers according to the invention in the form of coextruded layers contain from 0.05 to 20 wt. %, preferably from 0.1 to 15 wt. %, particularly preferably from 0.5 to 10 wt. %, of mixtures of the UV absorbers of formulae (I) and (II) in the above-described mixing ratio, wherein coextruded layers having a layer thickness of 2 μm contain at least 10 wt. %, preferably ≧15 wt. %, those of 10 μm contain at least 2 wt. %, preferably ≧3 wt. %, and those of 30 μm contain at least 0.7 wt. %, preferably ≧1 wt. %. The percentages by weight are based on the total weight of layer (B).

For layer thicknesses from 2 μm to 2 mm, preferably from 50 μm to 1 mm, particularly preferably from 80 μm to 500 μm, the UV protective layers according to the invention in the form of films contain from 0.01 to 20 wt. %, preferably from 0.02 to 5 wt. %, particularly preferably from 0.04 to 2 wt. %, of mixtures of the UV absorbers of formulae (I) and (II) in the above-described mixing ratio, wherein films having a layer thickness of 80 μm contain at least 0.25 wt. %, preferably ≧0.4 wt. %, those of 200 μm contain at least 0.1 wt. %, preferably 0.15 wt. %, and those of 500 μm contain at least 0.04 wt. %, preferably ≧0.06 wt. %. The percentages by weight are based on the total weight of layer (B).

A further stabilisation of the UV protective layer can be achieved by using in addition to the triazines, that is to say the actual UV absorbers, also so-called HALS systems (Hindered Amine Light Stabilizer) of the general formula (IIIa)

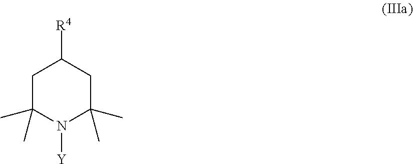

wherein Y represents H, R¹ or OR¹ and R¹ is in each case branched or unbranched C₁-C₁₃-alkyl, C₂-C₂₀-alkenyl, C₆-C₁₂-aryl or —CO—C₁-C₁₈-alkyl, R² is H or branched or unbranched C₁-C₈-alkyl, and R³ denotes C₁-C₁₂-alkyl; C₂-C₁₂-alkenyl or C₅-C₆-cycloalkyl.

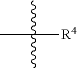

is composed of:

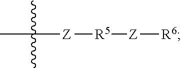

in particular

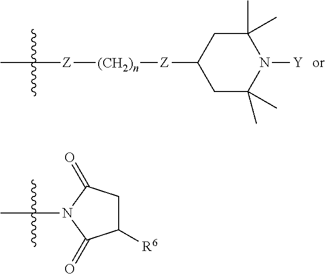

so that the following formulae are obtained

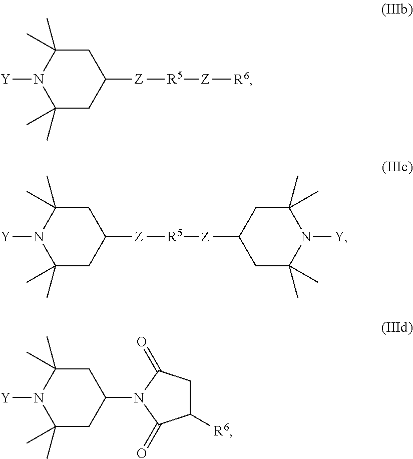

wherein

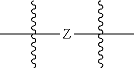

is a divalent functional group such as

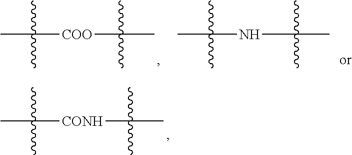

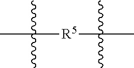

is a divalent organic radical such as

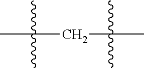

wherein n=from 0 to 12 or :C═CH—Ph—OCH₃.

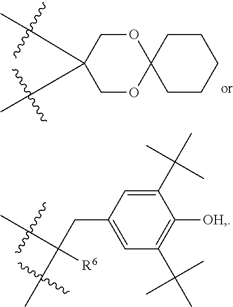

R⁶ is H or C₁-C₂₀-alkyl.

For UV protective layers in the form of cured lacquer formulations, preferably Y=R¹ and

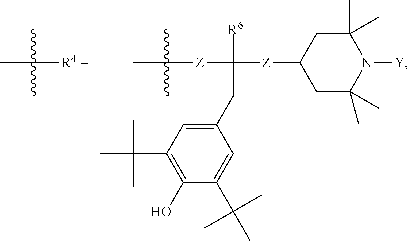

particularly preferably Y=R¹ where R¹=C₁-C₁₃-alkyl and

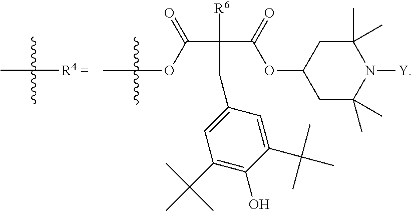

This gives the following group of the preferred compounds of the general formula (IIIe)

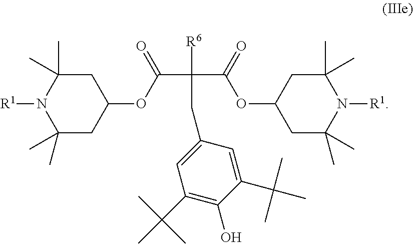

The UV protective layers according to the invention in the form of cured lacquer formulations contain from 0 to 5 wt. %, preferably from 0 to 3 wt. %, particularly preferably from 0.5 to 2 wt. %, of the compound of formula (III), based on the solids content of the lacquer formulation. When the particularly preferred amount of the particularly preferred HALS system (IIIe) is used, the necessary amount of UV absorber mixture of (I) and (II) is reduced to preferably ≧10 wt. % for a layer thickness after application and curing of 1 μm, preferably ≧2 wt. % for 5 μm and preferably ≧1 wt. % for 10 μm.

HALS systems can also be used in the case of UV protective layers in the form of coextruded layers and of films, in amounts of from 0 to 3 wt. %. However, owing to the higher processing temperatures, higher molecular weight HALS systems are here preferred, in which the functional group (IIIf) contained in formula IIIa is present more than twice per molecule

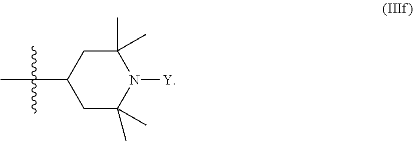

Particular preference is given to high molecular weight HALS systems whose weight loss at 300° C., determined by TGA with a heating rate of 20° C. per minute in air, is 3 wt. %, such as, for example, the compounds of formula (IIIg), which are obtainable, for example, as Chimassorb 119 from Ciba

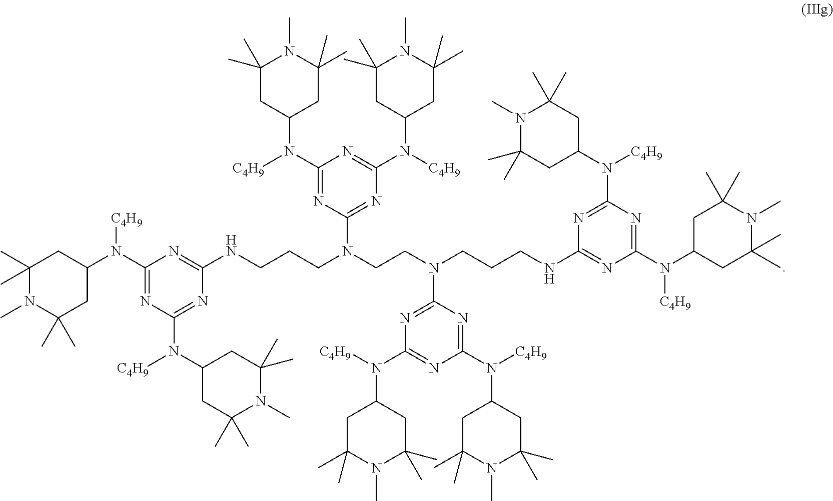

Suitable polycarbonates for layer (A) of the multilayer products according to the invention are all known polycarbonates; they can be homopolycarbonates, copolycarbonates and thermoplastic polyester carbonates.

They preferably have mean molecular weights M̅_{w} of from 18,000 to 40,000, preferably from 22,000 to 36,000 and in particular from 24,000 to 33,000, determined by measuring the relative solution viscosity in dichloromethane or in mixtures of equal amounts by weight of phenol/o-dichlorobenzene calibrated by light scattering.

For the preparation of polycarbonates, reference may be made, for example, to “Schnell, Chemistry and Physics of Polycarbonates, Polymer Reviews, Vol. 9, Interscience Publishers, New York, London, Sydney 1964”, and to “D. C. PREVORSEK, B. T. DEBONA and Y. KESTEN, Corporate Research Center, Allied Chemical Corporation, Morristown, N.J. 07960, ‘Synthesis of Poly(ester)carbonate Copolymers’ in Journal of Polymer Science, Polymer Chemistry Edition, Vol. 19, 75-90 (1980)”, and to “D. Freitag, U. Grigo, P. R. Müller, N. Nouvertne, BAYER AG, ‘Polycarbonates’ in Encyclopedia of Polymer Science and Engineering, Vol. 11, Second Edition, 1988, pages 648-718” and finally to “Dres. U. Grigo, K. Kircher and P. R. Müller ‘Polycarbonate’ in Becker/Braun, Kunststoff-Handbuch, Volume 3/1, Polycarbonate, Polyacetale, Polyester, Celluloseester, Carl Hanser Verlag Munich, Vienna 1992, pages 117-299”.

The preparation of the polycarbonates is preferably carried out by the interfacial process or the melt transesterification process and is described by way of example hereinbelow with reference to the interfacial process.

Compounds which are preferably to be used as starting compounds are bisphenols of the general formula

HO—R⁷—OH,

wherein R⁷ is a divalent organic radical having from 6 to 30 carbon atoms which contains one or more aromatic groups.

Examples of such compounds are bisphenols which belong to the group of the dihydroxydiphenyls, bis(hydroxyphenyl)alkanes, indane bisphenols, bis(hydroxyphenyl) ethers, bis(hydroxyphenyl)-sulfones, bis(hydroxyphenyl) ketones and α,α′-bis(hydroxyphenyl)-diisopropylbenzenes.

Particularly preferred bisphenols which belong to the above-mentioned groups of compounds are bisphenol A, tetraalkyl bisphenol A, 4,4-(meta-phenylenediisopropyl) diphenol (bisphenol M), 4,4-(para-phenylenediisopropyl) diphenol, 1,1-bis-(4-hydroxyphenyl)-3,3,5-trimethylcyclohexane (BP-TMC) and optionally mixtures thereof.

The bisphenol compounds to be used according to the invention are preferably reacted with carbonic acid compounds, in particular phosgene, or, in the melt transesterification process, with diphenyl carbonate or dimethyl carbonate.

Polyester carbonates are obtained preferably by reaction of the bisphenols already mentioned, at least one aromatic dicarboxylic acid and optionally carbonic acid equivalents. Suitable aromatic dicarboxylic acids are, for example, phthalic acid, terephthalic acid, isophthalic acid, 3,3′- or 4,4′-diphenyldicarboxylic acid and benzophenonedicarboxylic acids. Some, up to 80 mol %, preferably from 20 to 50 mol %, of the carbonate groups in the polycarbonates can be replaced by aromatic dicarboxylic acid ester groups.

Inert organic solvents used in the interfacial process are, for example, dichloromethane, the various dichloroethanes and chloropropane compounds, tetrachloromethane, trichloromethane, chlorobenzene and chlorotoluene; chlorobenzene or dichloromethane, or mixtures of dichloromethane and chlorobenzene, are preferably used.

The interfacial reaction can be accelerated by catalysts such as tertiary amines, in particular N-alkylpiperidines or onium salts. Preference is given to the use of tributylamine, triethylamine and N-ethylpiperidine. In the case of the melt transesterification process, the catalysts mentioned in DE-A 4 238 123 are preferably used.

The polycarbonates can be linear or branched. Mixtures of branched and unbranched polycarbonates can also be used.

The polycarbonates can be branched in a deliberate and controlled manner by the use of small amounts of branching agents. Some suitable branching agents are: phloroglucinol, 4,6-dimethyl-2,4,6-tri-(4-hydroxyphenyl)-hept-2-ene; 4,6-dimethyl-2,4,6-tri-(4-hydroxyphenyl)-heptane; 1,3,5-tri-(4-hydroxyphenyl)-benzene; 1,1,1-tri-(4-hydroxyphenyl)-ethane; tri-(4-hydroxyphenyl)-phenyl-methane; 2,2-bis-[4,4-bis-(4-hydroxyphenyl)-cyclohexyl]-propane; 2,4-bis-(4-hydroxyphenyl-isopropyl)-phenol; 2,6-bis-(2-hydroxy-5′-methyl-benzyl)-4-methylphenol; 2-(4-hydroxyphenyl)-2-(2,4-dihydroxyphenyl)-propane; hexa-(4-(4-hydroxyphenyl-isopropyl)-phenyl)-orthoterephthalic acid ester; tetra-(4-hydroxyphenyl)-methane; tetra-(4-(4-hydroxyphenyl-isopropyl)-phenoxy)-methane; α,α′, α″-tris-(4-hydroxyphenyl)-1,3,5-triisopropylbenzene; 2,4-dihydroxybenzoic acid; trimesic acid; cyanuric chloride; 3,3-bis-(3-methyl-4-hydroxyphenyl)-2-oxo-2,3-dihydroindole; 1,4-bis-(4′,4″-dihydroxytriphenyl)-methyl)-benzene and in particular: 1,1,1-tri-(4-hydroxyphenyl)-ethane and bis-(3-methyl-4-hydroxyphenyl)-2-oxo-2,3-dihydroindole.

The branching agents or mixtures of branching agents which are optionally to be used concomitantly in an amount of from 0.05 to 2 mol %, based on diphenols used, can be used together with the diphenols or, alternatively, can be added at a later stage of the synthesis.

Suitable branching agents for polycarbonates are known from the literature and are described, for example, in patent specifications U.S. Pat. No. 4,185,009, DE-A 25 00 092, DE-A 42 40 313, DE-A 19 943 642, U.S. Pat. No. 5,367,044 and in the literature cited therein. The polycarbonates used can additionally also be intrinsically branched, in which case no branching agent is added within the context of the polycarbonate preparation. An example of intrinsic branchings are so-called Fries structures, as are disclosed in EP-A 1 506 249 for melt polycarbonates.

As chain terminators there are preferably used phenols such as phenol, alkylphenols such as cresol and 4-tert-butylphenol, chlorophenol, bromophenol, cumylphenol or mixtures thereof in amounts of from 1 to 20 mol %, preferably from 2 to 10 mol %, per mol of bisphenol. Phenol, 4-tert-butylphenol and cumylphenol are preferred.

Chain terminators and branching agents can be added to the syntheses separately or together with the bisphenol.

Polycarbonates which are preferred according to the invention for layer A of the multilayer product according to the invention are the homopolycarbonate based on bisphenol A, the homopolycarbonate based on 1,1-bis-(4-hydroxyphenyl)-3,3,5-trimethylcyclohexane and the copolycarbonates based on the two monomers bisphenol A and 1,1-bis-(4-hydroxyphenyl)-3,3,5-trimethylcyclohexane.

The homopolycarbonate based on bisphenol A is particularly preferred.

The polycarbonate can contain stabilisers. Suitable stabilisers are, for example, phosphines, phosphites or Si-containing stabilisers and further compounds described in EP-A 0 500 496. Examples which may be mentioned are triphenyl phosphites, diphenylalkyl phosphites, phenyldialkyl phosphites, tris-(nonylphenyl) phosphite, tetrakis-(2,4-di-tert-butylphenyl)-4,4′-biphenylene diphosphonite and triaryl phosphite. Triphenylphosphine and tris-(2,4-di-tert-butylphenyl) phosphite are particularly preferred.

The polycarbonate-containing layer (A) of the multilayer product according to the invention can further contain from 0.01 to 0.5 wt. % of the esters or partial esters of mono- to hexa-hydric alcohols, in particular of glycerol, of pentaerythritol or of Guerbet alcohols.

Monohydric alcohols are, for example, stearyl alcohol, palmityl alcohol and Guerbet alcohols.

A dihydric alcohol is, for example, glycol.

A trihydric alcohol is, for example, glycerol.

Tetrahydric alcohols are, for example, pentaerythritol and mesoerythritol.

Pentahydric alcohols are, for example, arabitol, ribitol and xylitol.

Hexahydric alcohols are, for example, mannitol, glucitol (sorbitol) and dulcitol.

The esters are preferably the monoesters, diesters, triesters, tetraesters, pentaesters and hexaesters or mixtures thereof, in particular random mixtures, of saturated, aliphatic C₁₀- to C₃₆-monocarboxylic acids and optionally hydroxy-monocarboxylic acids, preferably with saturated, aliphatic C₁₄- to C₃₂-monocarboxylic acids and optionally hydroxy-monocarboxylic acids.

The commercially available fatty acid esters, in particular of pentaerythritol and of glycerol, can, contain <60% of different partial esters as a result of their preparation.

Saturated, aliphatic' monocarboxylic acids having from 10 to 36 carbon atoms are, for example, capric acid, lauric acid, myristic acid, palmitic acid, stearic acid, hydroxystearic acid, arachidic acid, behenic acid, lignoceric acid, cerotic acid and montanic acids.

Preferred saturated, aliphatic monocarboxylic acids having from 14 to 22 carbon atoms are, for example, myristic acid, palmitic acid, stearic acid, hydroxystearic acid, arachidic acid and behenic acid.

Saturated, aliphatic monocarboxylic acids such as palmitic acid, stearic acid and hydroxystearic acid are particularly preferred.

The saturated, aliphatic C₁₀- to C₃₆-carboxylic acids and the fatty acid esters are either known per se in the literature or can be prepared by processes known in the literature. Examples of pentaerythritol fatty acid esters are those of the particularly preferred monocarboxylic acids mentioned above.

Esters of pentaerythritol and of glycerol with stearic acid and palmitic acid are particularly preferred.

Esters of Guerbet alcohols and of glycerol with stearic acid and palmitic acid and optionally hydroxystearic acid are also particularly preferred.

The multilayer products according to the invention can contain, in addition to the UV absorbers and HALS systems according to the invention, organic colourings, inorganic colouring pigments, fluorescent dyes, further UV absorbers apart from the UV protective layers (B) and/or (D), IR absorbers and, particularly preferably, optical brightening agents.

The production of layer (A) can be carried out, for example, by extrusion or by single- or multi-component injection moulding processes.

The production of the UV protective layers (B) and (D) according to the invention is carried out either by preparing a compound (a) from (a1) a polyacrylate, consisting of alkyl methacrylate, preferably having alkyl chain lengths below 10 carbon atoms (—CₙH₂ₙ₊₁ where n<10), particularly preferably exclusively with n=1 (methyl methacrylate) and (a2) a mixture of a biphenyl-substituted triazine of the general formula (I) and a phenyl-substituted triazine of the general formula (II). The compound (a) is then either (i) coextruded with polycarbonate in such a manner that a thin UV protective layer of compound (a) is located on the polycarbonate surface with good adhesion, or (ii) the compound (a) is processed further to a thin film which is subsequently back-injected or laminated with polycarbonate to form a firmly adhering composite. Coextrusion itself has been described many times in the literature. It is thereby possible, by using one or more lateral extruders and a multichannel die, or optionally suitable melt adapters upstream of a sheet die, to lay thermoplastic melts of different compositions on top of one another and thus produce multilayer sheets or films (for coextrusion see, for example, EP-A 0 110 221, EP-A 0 110 238 and EP-A 0 716 919, for details of the adapter and die process see Johannaber/Ast: “Kunststoff-Maschinenführer”, Hanser Verlag, 2000 and in Gesellschaft Kunststofftechnik: “Koextrudierte Folien und Platten: Zukunftsperspektiven, Anforderungen, Anlagen und Herstellung, Qualitätssicherung”, VDI-Verlag, 1990). On the subject of the back-injection of films see inter alia Plastverarbeiter 47 (1996) No .8_{—}18ff.

Alternatively, the production of the UV protective layers (B) and (D) according to the invention is carried out by incorporating (b2) a mixture of a biphenyl-substituted triazine of the general formula (I) and a phenyl-substituted triazine of the general formula (II) into a lacquer formulation (b) containing (b1) a polyacrylate resin, containing methyl methacrylate as the main component and optionally a further alkyl methacrylate having a longer, linear or branched alkyl chain (—CₙH₂ₙ₊₁ where n>1), preferably 1≦n≦10, particularly preferably linear with n=3 (butyl methacrylate), and one or more solvents, as well as optionally further lacquer additives such as, for example, fillers, flow agents, radical acceptors, etc. The UV-absorber-containing lacquer formulation (b) is then applied to the surface of a polycarbonate moulding by means of flood coating, dipping, spraying, roller coating or spin coating and subsequently physically dried, so that a firmly adhering coating on PC is obtained (see also: Goldschmidt, Streitberger: Lackiertechnik, BASF Coatings AG, Vincentz Verlag, Hanover, 2002, p. 496 ff).

The UV-stabilised scratch-resistant layer(s) (C) and (E) of the multilayer products according to the invention are preferably produced by coating the UV protective layer(s) or the uncoated polycarbonate with scratch-resistant or wear-resistant coating systems. To that end, a formulation of a scratch-resistant or wear-resistant lacquer, for example of a polysiloxane lacquer (sol-gel lacquer) or of a hybrid lacquer, is applied to the surface of the UV protective layer(s) or of the uncoated polycarbonate by flood coating, dipping, spraying, roller coating or spin coating and is then cured to form a firmly adhering PC/UV protective layer/scratch-resistant layer composite or, in the case of the structure (E)-(A)-(B)-(C), to form a firmly adhering scratch-resistant layer/PC composite.

Sol-gel lacquers within the scope of the present invention are lacquers produced by the sol-gel process. The sol-gel process is a process for the synthesis of non-metallic inorganic or hybrid-polymeric materials from colloidal dispersions, the so-called sols.

For example, such sol-gel coating solutions can be produced by hydrolysis of aqueous dispersions of colloidal silicon dioxide and an organoalkoxysilane and/or an alkoxysilane or mixtures of organoalkoxysilanes of the general formula RSi(OR′)₃ and/or alkoxysilanes of the general formula Si(OR′)₄, wherein in the organoalkoxysilane(s) of the general formula RSi(OR′)₃ R represents a monovalent C1- to C6-alkyl radical or a completely or partially fluorinated C1-C6-alkyl radical, a vinyl or allyl unit, an aryl radical or a C1-C6-alkoxy group. R is particularly preferably a C1- to C4-alkyl group, a methyl, ethyl, n-propyl, isopropyl, tert-butyl, sec-butyl or n-butyl group, a vinyl, allyl, phenyl or substituted phenyl unit. The —OR′ are selected independently of one another from the group containing C1- to C6-alkoxy groups, a hydroxy group, a formyl unit and an acetyl unit. Sol-gel polysiloxane lacquers in some cases also fall under the definition of a hybrid lacquer.

The colloidal silicon dioxide is obtainable, for example, as e.g. Levasil 200 A (HC Starck), Nalco 1034A (Nalco Chemical Co), Ludox AS-40 or Ludox LS (GRACE Davison). The following compounds may be mentioned as examples of organoalkoxysilanes: 3,3,3-trifluoropropyltrimethoxysilane, methyltrimethoxysilane, methyltrihydroxysilane, methyltriethoxysilane, ethyltrimethoxysilane, methyltriacetoxysilane, ethyltriethoxysilane, phenyltrialkoxysilane (e.g. phenyltriethoxysilane and phenyltrimethoxysilane) and mixtures thereof. The following compounds may be mentioned as examples of alkoxysilanes: tetramethoxysilane and tetraethoxysilane and mixtures thereof.

Organic and/or inorganic acids or bases, for example, can be used as catalysts.

In an embodiment, the colloidal silicon dioxide particles can also be formed in situ by precondensation starting from alkoxysilanes (see in this connection “The Chemistry of Silica”, Ralph K. Iler, John Wiley & Sons, (1979), p. 312-461).

The hydrolysis of the sol-gel solution is terminated or slowed considerably by addition of solvents, preferably alcoholic solvents such as, for example, isopropanol, n-butanol, isobutanol or mixtures thereof. Then one or more UV absorbers, which have optionally been predissolved in a solvent, are added to the sol-gel coating solution, following which there is an ageing step of a few hours or several days/weeks. Further additives and/or stabilisers such as, for example, flow agents, surface additives, thickeners, pigments, colourings, curing catalysts, IR absorbers and/or adhesion promoters can further be added. The use of hexamethyl-disilazane or comparable compounds, which can lead to a reduced susceptibility of the coatings to cracking, is also possible (see also WO 2008/109072 A).

Hybrid lacquers within the scope of the present invention are based on the use of hybrid polymers as binders. Hybrid polymers (hybrid: lat. “of dual origin”) are polymeric materials in which structural units of different material classes are combined at a molecular level. Owing to their structure, hybrid polymers can exhibit wholly novel property combinations. Unlike composite materials (defined phase boundaries, weak interactions between the phases) and nanocomposites (use of nano-scale fillers), the structural units of hybrid polymers are linked together at molecular level. This is achieved by chemical processes such as, for example, the sol-gel process, with which organic networks can be built up. By the use of organically reactive precursors, for example organically modified metal alkoxides, organic oligomer/polymer structures can additionally be produced. Acrylate lacquers containing surface-modified nanoparticles, which form an organic/inorganic network after curing, are likewise defined as hybrid lacquers. There are thermally curable and UV-curable hybrid lacquers.

Thermal, UV-stabilised sol-gel lacquers are obtainable, for example, from Momentive Performance Materials under the product names AS4000 and AS4700. At layer thicknesses of from 1 to 20 μm, preferably from 2 to 15 μm, particularly preferably from 4 to 12 μm, sol-gel polysiloxane lacquers have an extinction between 0.2 and 4, preferably 0.2 and 2, particularly preferably 0.3≦extinction (sol-gel layer)≦1.5.

Possible thermally curable hybrid lacquers are available commercially as PHC587B or PHC587C from Momentive Performance Materials, or are described in EP-A 0 570 165. The layer thickness should be from 1 to 20 μm, preferably from 3 to 15 μm, particularly preferably from 6 to 8 μm.

UV-curable hybrid lacquers are, for example, UV-curable acrylate lacquers or UV-curable anhydrous hydrolysable silane systems, as are described in WO 2008/071363 A or DE-A 2804283. A commercially available system is UVHC3000 (Momentive Performance Materials). The layer thickness should be from 1 to 25 μm, preferably from 4 to 20 μm, particularly preferably from 8 to 12 μm. The scratch-resistant layers based on hybrid lacquers should have an extinction at 340 nm between 0.1 and 3, preferably between 0.2 and 2.5, particularly preferably 0.3≦extinction (hybrid layer)≦2.

As UV absorbers there may be used the commercially available, moderately polar, mostly hydroxy-containing UV absorbers and/or inorganic UV absorbers, such as titanium dioxide, zinc oxide or cerium oxide (EP-A 0 931 820). UV absorbers modified by an alkoxy-silyl(alkyl) group for such lacquer systems based on resorcinol have been disclosed in U.S. Pat. No. 5,391,795 and U.S. Pat. No. 5,679,820.

Further typical UV absorber classes which can be used in the scratch-resistant layer are 2-hydroxy-benzophenones, 2-(2-hydroxyphenyl)benzotriazoles, 2-(2-hydroxyphenyl)-1,3,5-triazines, 2-cyanoacrylates and oxalanilides. Modification with a group which leads to increased solubility, such as, for example, an alkoxysilylalkyl group, may be expedient. The maximum concentration of the UV absorber is determined by its solubility. The minimum concentration is given by the desired extinction of the scratch-resistant layer, which should be at least 0.2 and 2.5, particularly preferably 0.3≦extinction (scratch-resistant layer)≦2. UV absorber contents of from 0.5 to 20 wt. %, based on the solids content of the scratch-resistant lacquer, are typical.

Application of the scratch-resistant layers is carried out by processes known in the prior art (e.g. bake-on-bake, wet-on-wet processes) or as specified by the manufacturer.

The multilayer products are preferably selected from the group consisting of sheets, films and three-dimensional moulded articles.

The present invention likewise provides the use of said multilayer products in particular for moulded articles for outdoor applications having permanently high demands in respect of the visual impression, such as, for example, glazing. Fields of application are also found in the field of one-component and two-component injection moulded parts, for example in the form of headlamp cover plates, architectural and automotive glazing.

The invention is explained further by the following examples, without being limited thereto. The examples according to the invention merely give preferred embodiments of the present invention.

### EXAMPLES

### Examples 1-10

### A) Preparation of the UV-Absorber-Containing PMMA Lacquer Solutions

7.2 g of Elvacite 2021 (Lucite International, UK) are dissolved in 36.4 g of each of diacetone alcohol and methoxypropanol. There are then added 0.4 g of BYK 300 (BYK Additives and Instruments, Germany), 0.14 g of Tinuvin 144 (Ciba, Switzerland) and a total of 0.7 g of UV absorber (for details see Examples 1 to 10; the absorbers mentioned here are available commercially from Ciba, Switzerland) (which corresponds to 10 wt. %, based on the solids content of the lacquer). The lacquer is stirred until the individual components have dissolved completely and is filtered over a suction filter (2-4 μm cellulose filter).

### B) Application of UV Protective Layer (B)

Optical-grade polycarbonate (PC) sheets of Makrolon® 2808 (Examples 1-5, Bayer MaterialScience AG; medium-viscosity bisphenol A polycarbonate, MVR 10 g/10 min according to ISO 1133 at 300° C. and 1.2 kg, without UV stabilisation) or Makrolon® AL 2647 (Examples 6-10, Bayer MaterialScience AG; medium-viscosity bisphenol A polycarbonate with UV stabiliser and mould release agent; MFR 13 g/10 min according to ISO1133 at 300° C. and 1.2 kg) are produced in a size of 10×15'0.32 cm on a Klöckner Ferromatik FM160 with a 45 injection unit at a melt temperature of 300° C., a tool temperature of 90° C. with an injection rate of about 30 mm/sec. and a cycle time of about 50 sec. These injection-moulded PC sheets are tempered for one hour at 120° C., rinsed with isopropanol and exposed to air. Then the sheets are coated with each of the UV-absorber-containing PMMA lacquer solutions according to Examples 1-10 below (angle of inclination about 25-45%, temperature of the UV protective solution 23° C., room temperature 23° C., relative humidity 22%), exposed to air for 10 minutes at room temperature, and the coating is baked for 30 minutes at 120° C.

### Example 1: (Comparison)

Only 0.7 g of Tinuvin 479 (UV absorber of the general formula (I); CAS No. 204848-45-3) was used as the UV absorber in the UV protective layer. Coating was carried out on Makrolon® 2808.

### Example 2: (Comparison)

0.56 g of Tinuvin 479 and 0.14 g of Tinuvin 405 (CAS No. 137658-79-8; 2-[2-hydroxy-4-[3-(2-ethylhexyl-1-oxy)-2-hydroxypropyloxy]phenyl]-4,6bis(2,4-dimethylphenyl)-1,3,5-triazine) were used as UV absorbers. Coating was carried out on Makrolon® 2808.

### Example 3: (Comparison)

0.42 g of Tinuvin 479 and 0.28 g of Tinuvin 405 were used as UV absorbers. Coating was carried out on Makrolon® 2808.

### Example 4: (Comparison)

0.42 g of Tinuvin 479 and 0.28 g of Tinuvin 1577 (UV absorber of the general formula (II); CAS No. 147315-50-2; 2-(4,6-diphenyl-1,3,5-triazin-2-yl)-5-(hexyloxy)-phenol) were used as UV absorbers. Coating was carried out on Makrolon® 2808.

### Example 5: (According to the Invention)

0.56 g of Tinuvin 479 and 0.14 g of Tinuvin 1577 were used as UV absorbers. Coating was carried out on Makrolon® 2808.

### Example 6: (Comparison)

Only 0.7 g of Tinuvin 479 is used as UV absorber. Coating was carried out on Makrolon® AL2647.

### Example 7: (Comparison)

0.56 g of Tinuvin 479 and 0.14 g of Tinuvin 405 were used as UV absorbers. Coating was carried out on Makrolon® AL2647.

### Example 8: (Comparison)

0.42 g of Tinuvin 479 and 0.28 g of Tinuvin 405 were used as UV absorbers. Coating was carried out on Makrolon® AL2647.

### Example 9: (Comparison)

0.42 g of Tinuvin 479 and 0.28 g of Tinuvin 1577 were used as UV absorbers. Coating was carried out on Makrolon® AL2647.

### Example 10: (According to the Invention)

0.56 g of Tinuvin 479 and 0.14 g of Tinuvin 1577 were used as UV absorbers. Coating was carried out on Makrolon® AL2647.

### C) Application of the Scratch-Resistant Layer (C)

The sheet coated with the UV protective layer was flood-coated on the coated side with a commercially available, UV-absorber-containing sol-gel lacquer (AS4700, Momentive Performance Materials) (angle of inclination about 25-45%, temperature of the scratch-resistant solution 23° C., room temperature 23° C., relative humidity 22%). After 30 minutes' exposure to air at room temperature, the sheets are cured for one hour at 100° C.

### D) Tests:

The thickness of the transparent coatings was determined by means of an Eta SD 30 from Eta Optik GmbH.

The following adhesion tests were carried out:

a.) Adhesive tape pull-off (adhesive tape used 3M Scotch 610-1PK) with and without cross-cut (analogously to ISO 2409 or ASTM D 3359);

b.) Adhesive tape pull-off after 4 hours' storage in boiling water;

c.) Adhesive tape pull-off after 10 days' storage in water at about 65° C. (analogously to ISO 2812-2 and ASTM 870-02), and all were passed, that is to say the coating was not pulled off at all (rating 0 according to ISO 2409 or 5B according to ASTM D 3359).

Determination of the UV absorber degradation (UVAD) of the respective UV absorbers or mixture thereof in the UV protective layer produced plus the UV protection of the scratch-resistant lacquer on Makrolon® 2808 was carried out in an Atlas Ci 5000 Weatherometer with a radiation intensity of 0.75 W/m²/nm at 340 nm and a dry/rain cycle of 102:18 minutes over a total period of 3000 hours. The black panel temperature was 70° C., the sample chamber temperature was 55° C. and the humidity was 40%.

Examples 6-10 were likewise weathered in an Atlas Ci 5000 Weatherometer with a radiation intensity of 0.75 W/m²/nm at 340 nm and a dry/rain cycle of 102:18 minutes over a total period of 3000 hours. The black panel temperature was 70° C., the sample chamber temperature was 55° C. and the humidity was 40%. A UVAD is not possible owing to the UV protection in the polycarbonate.

The yellowness index is calculated as follows. The wavelength-dependent yellowing of the material is first determined according to the spectral sensitivity method (Interpretation of the spectral sensitivity and of the action spectrum of polymers, P. Trubiroha, Tagungsband der XXII. Donauländergespräche, 17.8.2001, Berlin, page 4-1). The spectral distribution of the UV light of the sun behind the UV protective layer is then calculated. The yellowing after weathering can be calculated from these two data sets in known manner by convolution and integration over time (see in this connection also: A. Geburtig, V. Wachtendorf, Tagungsband 34. Jahrestagung der Gesellschaft für Umweltsimulation, Umwelteinflüsse erfassen, simulieren and bewerten, 2.3.2005, Pfinztal, page 159).

The haze was determined according to ASTM D 1003 using a Haze Gard Plus from Byk-Gardner.

Results:

TABLE 1
Examples 1-5

| | Total | | | Haze after | YI after | UVAD |
|---|---|---|---|---|---|---|
| | layer | Initial | Initial | 3000 h | 3000 h | [MJ⁻¹] |
| Exam- | thickness | haze | extinction | weather- | weather- | at |
| ple | [μm] | [%] | at 340 nm | ing [%] | ing | 340 nm |
| 1 | 11.0 | 0.17 | 3.05 | 2.4 | 4.46 | 0.013 |
| 2 | 10.6 | 0.34 | 2.85 | 2.1 | 4.51 | 0.016 |
| 3 | 10.0 | 0.19 | 2.45 | 1.6 | 4.74 | 0.017 |
| 4 | 10.0 | 3.51 | * | * | * | * |
| 5 | 9.9 | 0.19 | 2.75 | 1.4 | 4.40 | 0.010 |

TABLE 2
Examples 6-10

| | Total layer | | | YI after |
|---|---|---|---|---|
| | thickness | Initial | Haze after 3000 h | 3000 h |
| Example | [μm] | haze [%] | weathering [%] | weathering |
| 6 | 10.4 | 0.32 | 0.9 | 1.71 |
| 7 | 10.6 | 0.23 | 0.95 | 1.61 |
| 8 | 10.3 | 0.13 | 0.8 | 1.70 |
| 9 | 10.0 | 5.13 | * | * |
| 10 | 10.0 | 0.21 | 0.7 | 1.61 |

* Not determined because of the high initial haze, caused by incompletely dissolved UV absorber.

The results show that on non-UV-stabilised polycarbonate (Examples 1 to 5), Example 5 according to the invention exhibits both the lowest haze and the lowest yellowing after 3000 hours' weathering. In addition, the UV absorber combination of Example 5 undergoes the least degradation, that is to say the extinction at 340 nm falls by only UVAD=0.01 per megajoule radiation dose. On UV-stabilised polycarbonate too (Examples 6 to 10), the lowest haze after 3000 hours' weathering is found with the structure according to the invention (Example 10). However, because of the additional UV protection in the polycarbonate, the weathering damage is not as pronounced as in Examples 1 to 5, but it will be seen that a comparable trend is achieved within the examples.

It is additionally apparent that too high a concentration of Tinuvin 1577 as in Examples 4 and 9 must not be used because the solubility of this UV absorber in the UV protective layer is obviously limited.

1-13. (canceled)

14. Multilayer product comprising at least a first layer (A), a second layer (B) and a third layer (C), wherein the first layer (A) contains a polycarbonate, the second layer (B) is a UV protective layer of polyalkyl (meth)acrylate and contains a combination of UV stabilisers according to
formula (I) 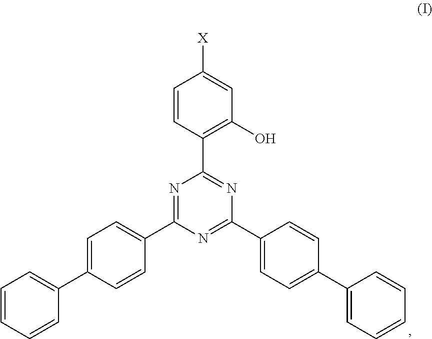
in which X denotes OR¹; OCH₂CH₂OR¹; OCH₂CH(OH)CH₂OR¹ or OCH(R²)COOR³, wherein R¹ represents in each case branched or unbranched C₁-C₁₃-alkyl, C₂-C₂₀-alkenyl, C₆-C₁₂-aryl or CO—C₁-C₁₈-alkyl; R² represents H or branched or unbranched C₁-C₈-alkyl; and R³ denotes C₁-C₁₂-alkyl; C₂-C₁₂-alkenyl or C₅-C₆-cycloalkyl,
and formula (II) 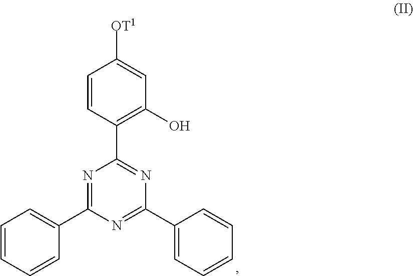
in which T¹ denotes C₁-C₁₈-alkyl or C₄-C₁₈-alkyl, interrupted by COO or OCO or O, or interrupted by O and substituted by OH,
and the third layer (C) is a UV-protected scratch-resistant lacquer.

15. Multilayer product according to claim 14, characterised in that layer (B) contains up to 5 wt. %, based on layer (B), of a stabiliser of formula (IIIa) 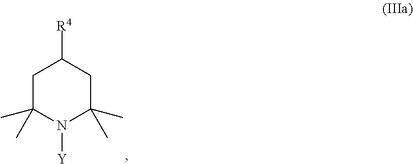
wherein Y represents H, R¹ or OR¹ and R¹ is in each case branched or unbranched C₁-C₁₃-alkyl, C₂-C₂₀-alkenyl, C₆-C₁₂-aryl or —CO—C₁-C₁₈-alkyl, R² is H or branched or unbranched C₁-C₈-alkyl, and R³ is C₁-C₁₂-alkyl; C₂-C₁₂-alkenyl or C₅-C₆-cycloalkyl, and 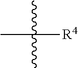
is composed 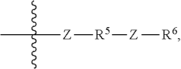
wherein 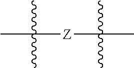
is a divalent functional group, 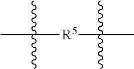
is a divalent organic radical and R⁶ is H or C₁-C₂₀-alkyl.

16. Multilayer product according to claim 15, wherein the stabiliser of formula (IIIa) is a compound of the general formula 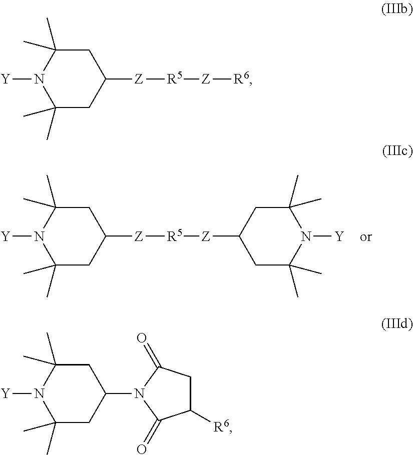
wherein 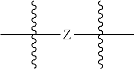
is a divalent functional group and 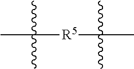
is a divalent organic radical and R⁶ is H or C₁-C₂₀-alkyl.

17. Multilayer product according to claim 14, characterised in that the UV absorbers of formulae (I) and (II) are used in layer (B) in the ratio UV absorber of formula (I): UV absorber of formula (II) of from 9.9:0.1 to 6.1:3.9.

18. Multilayer product according to claim 14, further comprising one or more further layers selected from the group containing
a. further UV protective layers (D) which are preferably likewise of polyalkyl methacrylate and each contain at least one UV stabiliser,
b. further scratch-resistant layers (E).

19. Multilayer product according to claim 14, characterised in that it has the layer sequence (C)-(B)-(A), (C)-(B)-(A)-(D)-(E) or (C)-(B)-(A)-E).

20. Multilayer product according to claim 14, characterised in that it comprises further functional layers (F).

21. Multilayer product according to claim 14, wherein layer (B) is a cured lacquer formulation having a layer thickness of from 1 to 100 μm, and the proportion of UV absorbers of formulae (I) and (II) in layer B together is from 0.5 to 20 wt. %, based on the solids content of the lacquer formulation (B).

22. Multilayer product according to claim 14, wherein layer (B) is a coextruded layer having a layer thickness of from 1 to 500 μm, and the proportion of UV absorbers of formulae (I) and (II) in layer (B) together is from 0.05 to 20 wt. %, based on the total weight of layer (B).

23. Multilayer product according to claim 14, wherein layer (B) is a film having a layer thickness of from 2 μm to 2 mm, and the proportion of UV absorbers of formulae (I) and (II) in layer (B) together is from 0.01 to 20 wt. %, based on the total weight of layer (B).

24. Multilayer product according to claim 14, characterised in that the layers (C) and optionally (E) are a UV-absorber-containing lacquer layer based on a sol-gel siloxane lacquer, a thermally curable hybrid lacquer and/or a UV-curable hybrid lacquer.

25. Multilayer product according to claim 14, wherein layer (A) is produced by extrusion or by single- or multi-component injection moulding.

26. Use of multilayer products according to claim 14 for outdoor applications with permanently high demands in respect of the visual impression, in particular for automotive and architectural glazing.
